(19) United States
(12) Patent Application Publication
(10) Pub. No.: US 2004/0023638 A1
(43) Pub. Date: Feb. 5, 2004

(54) Electric utility meter internal antenna

(75) Inventor: Leslie J. Reading, Tempe, AZ (US)

Correspondence Address: LADAS & PARRY, 26 WEST 61ST STREET, NEW YORK, NY, 10023, US

(73) Assignee: GALTRONICS LTD

(21) Appl. No.: 10/460,740

(22) Filed: Jun. 12, 2003

Related U.S. Application Data
(60) Provisional application No. 60/388,540, filed on Jun. 12, 2002.

(51) Int. Cl. H04M 11/00

(52) U.S. Cl. 455/405

(57) ABSTRACT

A wireless transmitting utility meter including a utility usage metering subsystem, a meter status sensing subsystem operative to sense a status of the utility usage metering subsystem and to provide a meter reading output, a wireless transmitter operative to receive the meter reading output and to provide a transmitter output and an antenna receiving the transmitter output and providing a wireless transmission, at least a portion of the antenna forming part of the utility usage metering subsystem.

### REFERENCE TO CO-PENDING APPLICATION

Applicant hereby claims priority of U.S. Provisional Patent Application Serial No. 60/388,540, filed Jun. 12, 2002, entitled “ELECTRIC UTILITY METER INTERNAL ANTENNA”.

### FIELD OF THE INVENTION

This invention applies to utility meters and more particularly to wireless transmitting utility meters and antennas therefor.

### BACKGROUND OF THE INVENTION

The following U.S. patent documents are believed to represent the current state of the art:

U.S. Pat. Nos. 6,414,605; 6,351,223 and 6,300,907.

### SUMMARY OF THE INVENTION

The present invention seeks to provide an improved wireless transmitting utility meter.

There is thus provided in accordance with a preferred embodiment of the present invention a wireless transmitting utility meter including a utility usage metering subsystem, a meter status sensing subsystem operative to sense a status of the utility usage metering subsystem and to provide a meter reading output, a wireless transmitter operative to receive the meter reading output and to provide a transmitter output and an antenna receiving the transmitter output and providing a wireless transmission, at least a portion of the antenna forming part of the utility usage metering subsystem.

In accordance with another preferred embodiment of the present invention the utility usage metering subsystem includes at least one planar metal element and the antenna employs at least one of the at least one planar metal element as a radiating element.

In accordance with yet another preferred embodiment of the present invention the utility usage metering subsystem includes first and second mutually spaced generally coplanar metal elements and wherein the antenna is a slot antenna employing the first and second mutually spaced generally coplanar metal elements as radiating elements. Additionally, the slot antenna includes a cavity-backed slot antenna. Alternatively or additionally, the first metal element is grounded and the second metal element receives the transmitter output.

In accordance with a further preferred embodiment of the present invention the wireless transmitting utility meter also includes a tab extending from the first metal element generally away from the second metal element and lies in a plane angled with respect to a plane of the first and second metal elements.

In accordance with another preferred embodiment of the present invention at least one of the at least one planar element includes a printed circuit board. Additionally, the printed circuit board provides a series capacitance matching the feedpoint impedance of the slot antenna to 50 ohms.

### BRIEF DESCRIPTION OF THE DRAWINGS

The present invention will be understood and appreciated more fully from the following detailed description, taken in conjunction with the drawings in which:

FIG. 1 is a simplified pictorial illustration of a wireless transmitting utility meter that also functions as an antenna, constructed and operative in accordance with a preferred embodiment of the present invention; and

FIG. 2 is a simplified side view pictorial illustration of the wireless transmitting utility meter of FIG. 1.

### DETAIL DESCRIPTION OF PREFERRED EMBODIMENTS

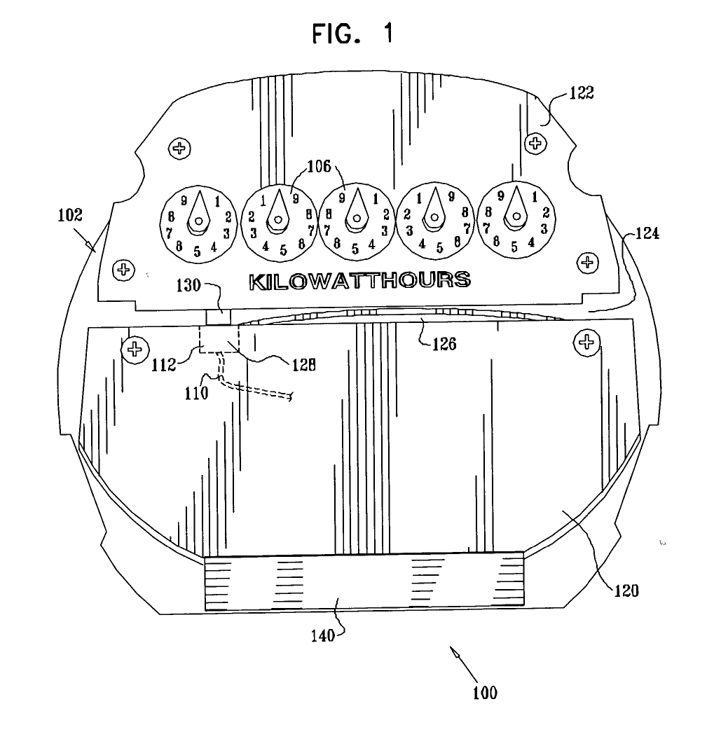

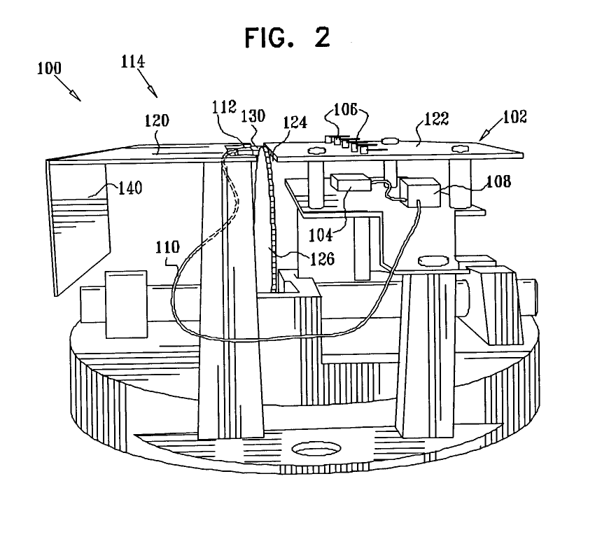

Reference is now made to FIGS. 1 and 2, which are simplified illustrations of a wireless transmitting utility meter constructed and operative in accordance with a preferred embodiment of the present invention.

As seen in FIGS. 1 and 2, a wireless transmitting utility meter 100 preferably comprises a utility usage metering subsystem 102, such as a conventional utility usage meter, operative to collect and display utility usage information. Utility meter 100 also includes a meter status sensing subsystem 104 operative to sense a status of the utility usage metering subsystem 102, such as a meter reading output as shown on dials 106. A wireless transmitter 108 is preferably provided to receive a meter reading output from subsystem 104 and to provide a transmitter output including meter reading information. The transmitter output is preferably provided via a coaxial cable 110 to an antenna feed location 112 forming part of an antenna 114. It is a particularly feature of the invention that at least a portion of the antenna 114 forms part of the utility usage metering subsystem 102.

In accordance with a preferred embodiment of the present invention, the utility usage metering subsystem 102 includes a first planar element 120 and a second planar element 122. First planar element 120 and second planar element 122 are preferably mutually spaced generally coplanar elements, preferably metal planar elements, defining a slot 124 therebetween. Subsystem 102 typically also includes a rotating disk 126, partially disposed in slot 124.

Antenna feed location 112 is preferably mounted onto an underside of first planar element 120 and preferably includes a printed circuit board 128, onto which is formed a conductor 130, which receives the transmitter output via coaxial cable 110 and is electrically connected to second planar element 122. Preferably, the first planar element 120 is grounded.

In accordance with a preferred embodiment of the present invention, the first and second planar elements 120 and 122 of utility usage metering subsystem 102 serve as radiating elements for a cavity-backed slot antenna defined thereby.

As further seen in FIGS. 1 and 2, first planar element 120 also preferably includes a tab 140 extending from first planar element 120 generally away from second planar element 122. Tab 140 generally lies in a plane that is angled with respect to a plane of the first and second planar elements 120 and 122. Tab 140 is provided so that first planar element 120 and second planar element 122 present approximately the same surface area, thus providing additional control over bandwidth and beam peak of the antenna.

Preferably, the feedpoint impedance of the slot 124 is matched to 50 ohms, by providing a series 2.0 pF capacitance. Alternatively, this value of capacitance may also be achieved by allowing the circuit board 128 to act as a capacitor.

Table 1 summarizes the performance of the antenna of the present invention.

TABLE 1

| | | | Gain | Term. | | | | |
|---|---|---|---|---|---|---|---|---|
| Beam | Frequency | Directivity | (Full | Gain (Full | | Ant. | Match | Terminal |
| # | (GHz) | (Full Sphere) | Sphere) | Sphere) | S11 | Efficiency | Efficiency | Efficiency |
| 1 | 0.902 | 7.69 | 6.36 | 5.97 | −10.65 | 73.54% | 91.39% | 67.21% |
| 2 | 0.911 | 7.22 | 6.31 | 6.16 | −14.95 | 80.92% | 96.80% | 78.34% |
| 3 | 0.919 | 7.12 | 6.10 | 6.08 | −23.05 | 79.03% | 99.51% | 78.64% |
| 4 | 0.928 | 7.33 | 6.37 | 6.34 | −21.27 | 80.06% | 99.25% | 79.46% |

It is appreciated that the present invention provides an antenna that fits in a minimal space yet provides a wider beamwidth, a higher antenna efficiency and a lower return loss than prior art antennas.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. A wireless transmitting utility meter comprising:
a utility usage metering subsystem;
a meter status sensing subsystem operative to sense a status of said utility usage metering subsystem and to provide a meter reading output;
a wireless transmitter operative to receive said meter reading output and to provide a transmitter output; and
an antenna receiving said transmitter output and providing a wireless transmission, at least a portion of said antenna forming part of said utility usage metering subsystem.

2. A wireless transmitting utility meter according to claim 1 and wherein said utility usage metering subsystem comprises at least one planar metal element and said antenna employs at least one of said at least one planar metal element as a radiating element.

3. A wireless transmitting utility meter according to claim 1 and wherein said utility usage metering subsystem comprises first and second mutually spaced generally coplanar metal elements and wherein said antenna is a slot antenna employing said first and second mutually spaced generally coplanar metal elements as radiating elements.

4. A wireless transmitting utility meter according to claim 3 and wherein said slot antenna comprises a cavity-backed slot antenna.

5. A wireless transmitting utility meter according to claim 3 and wherein said first metal element is grounded and said second metal element receives said transmitter output.

6. A wireless transmitting utility meter according to claim 5 and also comprising a tab extending from said first metal element generally away from said second metal element and lies in a plane angled with respect to a plane of said first and second metal elements.

7. A wireless transmitting utility meter according to claim 3 and wherein at least one of said at least one planar element comprises a printed circuit board.

8. A wireless transmitting utility meter according to claim 7 and wherein said printed circuit board provides a series capacitance matching the feedpoint impedance of said slot antenna to 50 ohms.
